(19) United States
(12) Patent Application Publication
(10) Pub. No.: US 2025/0314230 A1
(43) Pub. Date: Oct. 9, 2025

(54) SYSTEM FOR GENERATING ELECTRICITY WITH TANDEM TOWERS

(71) Applicant: Neil K. Nydegger, Rancho Santa Fe, CA (US)

(72) Inventor: Neil K. Nydegger, Rancho Santa Fe, CA (US)

(21) Appl. No.: 18/628,709

(22) Filed: Apr. 6, 2024

(51) Int. Cl. F03B 13/10; F03B 3/00

(52) U.S. Cl. CPC F03B 17/04; F05B 2220/706; F05B 2230/60; F05B 2260/422; F05B 2260/506

(57) ABSTRACT

A system for generating electricity using the earth's gravitational field for its motive force includes twin electricity generators. Each electricity generator includes a water tower that is vertically juxtaposed with a linear generator. A shuttle, when dropped from the top of a water tower accelerates for engagement with a linear generator at a constant engagement velocity. An electro-magnetic engagement between the shuttle and the linear generator provides the system's output. Its input is provided by a mechanical drive unit that reciprocatingly manipulates water levels in both of the water towers to drive the system.

### FIELD OF THE INVENTION

The present invention pertains to systems and machines that generate electricity using the Earth's gravitational field as a motive force. More particularly, the present invention pertains to mechanical devices that drive hydrodynamic systems for the purpose of generating electricity. The present invention is particularly, but not exclusively useful as self-sustaining systems that employ a pair of tandem electricity generators which have cumulative outputs driven by a common input.

### BACKGROUND OF THE INVENTION

Until recently, any consideration of combining the forces of “gravity” and “buoyancy” for the purpose of doing sustained meaningful work has been summarily dismissed for being ludicrous. The typical response has been that any contraption for doing work with these forces would have to be a perpetual motion machine, which is simply impossible. A problem supporting this dilemma is that buoyancy requires an object to weigh less than the volume of the medium, e.g. water, in which the object is submerged.

In the past, the gravity/buoyancy problem has been further debunked by the notion that in the earth's gravitational field a buoyant object moving up-and-down on a vertical path has an energy imbalance. Specifically, a buoyant object falling under the influence of gravity produces less energy than the energy required to lift the equivalent volume of water through the same vertical distance. However, this imbalance occurs only because the buoyant shuttle weighs less than the water volume that must be raised. The conclusion, however, has been based on static evaluations of the object based on potential energies.

U.S. Pat. No. 11,680,553, which was assigned to the assignee of the present invention, has addressed the above stated conclusions by further considering “power” (emphasis added), the time rate of doing work. This inclusion of an additional perspective for analysis introduces the concept of “energy” (emphasis added), which is the capacity to do work. Furthermore, an appreciation of the physics involved with the present invention requires a “steady state” analysis of the kinetic energy of a shuttle as it travels in dynamic equilibrium at a constant velocity. Specifically, it is the kinetic energy of a shuttle that is harvested by the present invention for commercial purposes.

In accordance with the present invention, the only motive force for moving a shuttle is the force of gravity. Accordingly, the shuttle is accelerated by the force of gravity in a downward direction. The present invention uses this fact to accelerate a shuttle from zero velocity at an elevated start point to a predetermined velocity for engagement with a linear generator. Thereafter, while engaged with the linear generator at a constant engagement velocity ve, the kinetic energy of the shuttle will generate work at a predetermined power. Upon disengagement from the linear generator, the buoyant shuttle returns upwardly through a water tower to the elevated start point by its buoyancy.

An object of the present invention is to provide a pair of electricity generators which will each produce equivalent output work units which are cumulative. Another object of the present invention is to provide input work from a common source for simultaneously operating both electricity generators during the same work cycle. Still another object of the present invention is to establish a self-sustaining joint operation of the electricity generators. Yet another object of the present invention is to provide a machine with two electricity generators that is simple to use, is easy to manufacture and is comparatively cost effective.

### SUMMARY OF THE INVENTION

Both a static and a dynamic, steady state, technical analysis of the machine's operational capabilities are required to evaluate its commercial value. Specifically, this requires considerations of work, the time rate of doing work (i.e. power), and the capacity to do work (i.e. kinetic energy). In the context of the present invention, these factors collectively apply in evaluations of the expressions for the machine's potential energy and kinetic energy.

In accordance with the present invention, a reciprocally driven Gravitas™ machine generates electricity with a pair of electricity generators which use a common piston for their operation. In this operation, the piston alternatingly drives each electricity generator individually.

Structurally, each electricity generator includes a water tower that is vertically aligned parallel with a linear generator. In this combination the electricity generators are mounted vertically in tandem on top of a hydro-mechanical drive unit.

Inside the hydro-mechanical drive unit, the piston is positioned to reciprocate in a water channel. Specifically, the piston is positioned across the water channel with its periphery connected between respective fore and aft bellows that extend from the piston in opposite directions along the water channel. In their cooperation with each other, these bellows allow for the reciprocating movements of the piston, back and forth (left and right) in the water channel. Importantly, with these piston movements there are corresponding back and forth movements of water in the water channel on opposite sides of the piston.

The importance of reciprocal water movements in the water channel is that these movements alternately operate the electricity generators.

A brief review of the physics involved in an operation of a Gravitas machine in accordance with the present invention is provided here to underscore its operational ability for commercial purposes. It is well known that a shuttle having a mass, mₛ, traveling at a constant velocity, vₑ, will maintain a kinetic energy value equal to ½mₛvₑ². Further, it is known that this kinetic energy can do output work Uₒ on a per second basis with an output power, Pₒ, which can be arbitrarily pre-selected depending on commercial purposes, i.e. Pₒ=Uₒ/sec and Uₒ=½mₛvₑ². Thus, there is a relationship between Pₒ, mₛ, and vₑ which can be used to design the shuttle for a Gravitas machine. Once the shuttle has been designed with reasonable operational values, the hydro-mechanical drive can then be designed to cooperatively operate the pair of electricity generators.

Structurally, the hydro-mechanical drive unit of the present invention involves an interaction between the piston, a recoil spring, and a circular drive cam. For its operation the drive cam will have a center of rotation that is off-set from the center of the circular cam by a predetermined radial distance s/2. Moreover, during each rotation of the cam, its interaction with the piston causes the piston to reciprocate. Thus, the duration of each consecutive machine work cycle can be measured as a 360° rotation of the cam.

Through an arrangement of interconnecting drive bars between the piston, the recoil spring, and the cam, each 360° rotation of the cam causes a reciprocal back-and-forth movement of the piston, and a reciprocal compression/decompression of the recoil spring. Both the piston movement and spring compression occur through the distance s. Because of the reciprocal nature of this 360° work cycle, each work cycle can be considered as having a first-half work cycle and a second-half work cycle.

During the first-half work cycle, i.e. as the cam rotates through an angle θ of 0°-180°, the piston is moved to the left in the water channel through the predetermined distance, s. Simultaneously during the first-half work cycle, the recoil spring is compressed through the same predetermined distance, s. Subsequently, during the second-half work cycle, i.e. during the rotation of the cam through the angle θ of 180°-360°, the piston is moved in reverse to the right in the water channel through the predetermined distance s. Specifically, this reverse piston movement is caused by the recoil spring as it decompresses (i.e. recoils) through the predetermined distance s.

From a work perspective, an operation of the hydro-mechanical drive produces two units of input work, 2Uᵢ, during the first-half work cycle θ=0°-180°. Specifically, one Uᵢ is performed by the piston as it moves water in the water channel through the distance s. Also, during the first-half work cycle, the other unit of input work, Uᵢ, is used to compress the recoil spring through the distance s. In effect, this Uᵢ, unit of input work is stored in the recoil spring. Then, during the second-half work cycle, θ=180°-360°, the input work unit Uᵢ which is stored in the recoil spring, is recovered as the spring decompresses (recoils) to move the water in a reverse direction to the right in the water channel through the distance s.

Functionally, during the first-half work cycle, the piston raises a predetermined volume of water in the water tower of one electricity generator with one Uᵢ. The value of this Uᵢ equals m_{w}gH, where m_{w} is the water mass being raised, g is gravity, and H is the head height of the water tower of the electricity generator in which the water is being raised. The other unit of work, Uᵢ, which is stored in the recoil spring, and is of equal value, is mathematically expressed as Uᵢ=ks, where k is the spring constant and s is the spring compression distance that is equal to the distance of piston movement. Consequently, Uᵢ=m_{w}gH=ks.

During the second-half work cycle, another unit of input work Uᵢ is required to move the piston in a reverse direction and to thereby raise water in the water tower of the other electricity generator. This input work unit Uᵢ, was stored in the recoil spring during the first-half work cycle. It is then released in the second-half work cycle as the spring decompresses (recoils) and returns to its start configuration. Thus, during a complete work cycle Uᵢ₍ₜₒₜₐₗ₎=(ks+m_{w}gH)=2Uᵢ.

Because the output power, Pₒ, of a Gravitas machine has a preselected, per second value, i.e. Pₒ=Uₒ/sec, shuttle velocity and time become significant considerations. For the present invention, it is the kinetic energy of a shuttle that will generate the power Pₒ of Uₒ/sec. This kinetic energy is mathematically expressed as Uₒ=½mₛvₑ², where mₛ is the shuttle's mass and vₑ is the constant engagement velocity of the shuttle with the electric generator. Thus, it happens that the total output work generated, Uₒ₍ₜₒₜₐₗ₎, with a linear generator can be evaluated in terms of the time duration the that a shuttle is engaged with a linear generator of length Lₑ. Specifically, vₑ=Lₑ/tₑ. For the present invention, the will be equal to the time duration of a half work cycle, e.g. the is the time duration of cam rotation through θ=0°-180°.

For the present invention, however, there are two electricity generators, each with its own shuttle and each with its own linear generator. Thus, each electricity generator will generate separate outputs Uₒ, but only during each half work cycle. However, when both electricity generators are considered together seriatum, the machine's total output generated is sequentially cumulative, i.e. Uₒ₍ₜₒₜₐₗ₎=2Uₒ. The consequence here is that for a complete 360° work cycle having a time duration of X seconds, the cumulative effect of Uₒ from both electricity generators, where tₑ=X/2, is (X/2)U₀+(X/2)Uₒ=2((X/2)U₀)=XUₒ. Thus,

Uₒ₍ₜₒₜₐₗ₎=XU₀

Operational control of a Gravitas machine is provided by a controller which is driven with feedback from Uₒ₍ₜₒₜₐₗ₎. Electronically, the controller is connected directly with the cam, the piston, and with the recoil spring, which cooperate in combination with each other to alternately move water volumes in the respective electricity generators back and forth, or forth and back. For this purpose, the controller is also electronically connected with a valving system which coordinates these water movements to thereby maintain proper water levels in the electricity generators. The controller also gauges the valving system with a predetermined constant angular rotation of the cam during the 360° work cycle. Further, the controller monitors shuttle movements in the respective electricity generators to coordinate shuttle movements with the rotation of the drive cam.

In the valving system of the machine, each electricity generator has an access valve and a transfer valve. Functionally, within each electricity generator these valves alternate between an open/closed configuration and a closed/open configuration. It is axiomatic that the access valve and the transfer valve can never be opened at the same time in their respective electricity generators.

To consider a work cycle, picture the electricity generators in a side-by-side relationship. Then, first consider the left-side electricity generator. At the beginning of the first-half work cycle, establish a time t₁ when the angle θ of the cam is in the range θ=(0°-5°). At the time t₁ the shuttle has already entered the water tower, the access valve has been closed behind the shuttle, and the transfer valve has been opened. This closed/open configuration is maintained as the now-submerged shuttle is directed to and through the transfer valve and into the water tower of the electricity generator. Also, during this first-half work cycle, a predetermine water volume is being lifted by the piston into the water tower of the left side electricity generator.

A time t₂ starts the beginning of the second-half work cycle for the left-side electricity generator. Specifically, t₂ occurs when the angle θ of the cam enters the range where θ=(180°-360°). At the time t₂, the shuttle has already entered the water tower of the left-side water tower, and the transfer valve has been closed. Thus, the access valve and the transfer valve of the left-side water tower has been switched by the controller back into an open/closed configuration with the access valve now open and the transfer valve closed in the left side electricity generator. As the shuttle rises by its buoyancy in the water tower of the left-side electricity generator, the piston reverses its direction and moves to lower the water level under the open access valve for the arrival of a subsequent shuttle.

Because both electricity generators operate similarly, but back-to-back, during respective half-work cycles their respective operations are successive. For instance, in the left-side electricity generator's first-half work cycle the piston is advanced to the left to thereby lift a predetermined water volume. During this same half-cycle, the piston is being retracted to thereby lower the water volume in the right-side electricity generator. On the other hand, in the second-half work cycle of the left-side electricity generator, these functions are reversed. Specifically, the piston is now advanced to the right in the water channel to lift a predetermined water volume in the right-side electricity generator. Also, as it is being retracted from the left-side electricity generator the water volume is lowered in the left-side electricity generator while the piston resets for the next machine work cycle. Simplistically stated, piston movements between the two electricity generators cause water movements in the respective electricity generators that mimic a seesaw.

For a general review of the reciprocally driven Gravitas machine, an important aspect of the machine's operation is that all movements of its internal components depend on the rotation of the drive cam. Further, a complete machine work cycle is completed with each 360° rotation of the cam. Accordingly, a complete 360° work cycle will include a first-half work cycle wherein the cam rotates as the angle θ increases between 0° and 180°, and a second-half work cycle wherein the cam rotates as the angle θ further increases between 180° and 360°.

As noted above, the differences between the half work cycles are that in the first-half work cycle (θ=0°-180°), the piston performs two different input works Uᵢ. In detail, one Uᵢ, raises the water level in a first electricity generator. At the same time, another Uᵢ compresses the recoil spring. In the second-half work cycle (θ=180°-360°), an input work Uᵢ is performed as the compressed recoil spring then decompresses (recoils) to reset the piston for another work cycle. In this process, the result for a Gravitas machine is that the total input work required, Uᵢ₍ₜₒₜₐₗ₎, will equal 2Uᵢ.

Meanwhile, as also disclosed above, during each complete work cycle (θ=0°-360°), the shuttle of each electricity generator will generate an electrical output of Uₒ/sec during a respective half work cycle of X/2 seconds. Specifically, one electricity generator will generate Uₒ/sec during the first-half work cycle, while the other electricity generator will generate Uₒ/sec during the second-half work cycle. Thus, during a complete work cycle of X seconds duration:

Uₒ₍ₜₒₜₐₗ₎=2(X/2)Uₒ=XUₒ and

Uₒ₍ₙₑₜ₎=XUₒ−2Uᵢ

The importance of X, the number of seconds in a work cycle, requires consideration of the relationship between Uᵢ and Uₒ and their respective potential energies. As disclosed above, the input work Uᵢ required of the piston is based on the potential energy of a water volume and will equal m_{w}gH during each half-cycle. On the other hand, the output work Uₒ generated by the shuttle during the half-cycle will equal its potential energy, which can be mathematically expressed as Uₒ=mₛgLₑ where mₛ is the mass of the shuttle and Lₑ is the length of the linear generator. Because the shuttle is buoyant, m_{w} must be greater than mₛ, (m_{w}>mₛ), e.g. a buoyancy factor B=0.7, is considered reasonable. Furthermore, for the shuttle to accelerate to a predetermined velocity vₑ for its engagement with the linear generator, H must be greater than Lₑ, (H>Lₑ). Consequently, in a static analysis Uᵢ will always be greater than Uₒ. The importance of this relationship on a per second basis is that the numerical ratio Uᵢ/Uₒ>1. Depending on several predetermined design factors such as the buoyancy factor B of the shuttle, the respective volumetric shuttle/water weights, the shuttle velocity vₑ, and the length Lₑ of the linear generator, the ratio Uᵢ/Uₒ will typically have a value around 1.6.

Thus far, power has been considered only for the purpose of structurally designing a machine. For an operational perspective, attention must be directed to a consideration of the time variables X, and how the required input work Uᵢ (required) is implemented.

A meaningful consideration of the power for the present invention involves a comparison of the total input work Uᵢ₍ₜₒₜₐₗ₎, that is required to operate the machine with the total output work, Uₒ₍ₜₒₜₐₗ₎, that is generated. For the input work required, i.e. U_{i(required)}, the fact is that U_{i(required)} is finite for each work cycle. This is so because only one unit of input work Uᵢ is required to raise water in a water tower during each machine work cycle. Note: this is so regardless of X. On the other hand, Uₒ₍ₜₒₜₐₗ₎ is cumulative. Specifically, Uₒ₍ₜₒₜₐₗ₎ is based directly on the relationship Pₒ=Uₒ/sec, which has a pre-selected value. The consequence of this is that one unit of output work, Uₒ, is generated every second. In tandem, the electricity generators operate sequentially, with each electricity generator providing one unit of output work, Uₒ/sec, during a half-cycle of X/2 seconds duration, i.e. (X/2)Uₒ. Thus for a complete cycle:

Uₒ₍ₜₒₜₐₗ₎=X Uₒ

As noted above, Uᵢ₍ₜₒₜₐₗ₎=Uᵢ which is based on the potential energy of a water volume being raised in the water tower of an electricity generator during a work cycle. Namely, Uᵢ=W_{w}H. Recall, in their relationship with each other, the ratio Uᵢ/Uₒ equals approximately 1.6. Accordingly, for one electricity generator, Uᵢ=1.6 Uₒ, and the total input work to operate two electricity generators during a machine work cycle will equal 3.2 Uₒ. The consequence of this is:

Uₒ₍ₙₑₜ₎=XUₒ−3.2Uₒ

### BRIEF DESCRIPTION OF THE DRAWINGS

The novel features of this invention, as well as the invention itself, both as to its structure and its operation, it will be best understood from the accompanying drawings, taken in conjunction with the accompanying description in which similar reference characters refer to similar parts, and in which:

FIG. 1 is a perspective view of a machine constructed in accordance with the present invention showing a pair of back-to-back output electricity generators mounted on a hydro-mechanical drive unit;

FIG. 2 is a schematic diagram of interactive components in the hydro-mechanical drive unit of the present invention;

FIG. 3 is a cross-sectional view of interactive components of the machine as would be seen along the line 3-3 in FIG. 1;

FIG. 4 is a top plan view of a cam for actuating the hydro-mechanical drive unit;

FIG. 5 is a graph of output work units resulting during each complete machine work cycle in a sequence of 360° rotations of the cam;

FIG. 6A is a free-body diagram of the machine's piston in a steady state condition of dynamic equilibrium;

FIG. 6B is a presentation of steady state, free-body diagrams for work accomplished by the piston to run both electricity generators of the machine during a 360° rotation of the cam;

FIG. 7A is a diagram showing the output work of a buoyant shuttle while engaged with a linear generator during a machine work cycle;

FIG. 7B is a graph showing the output work during a complete work cycle;

FIG. 8 is a schematic diagram of the control system for coordinating the operation of the machine's functional components;

FIG. 9 is a schematic diagram showing the temporal influence on shuttle locations, piston movements, and spring deformations during a 360° rotation of an drive cam; and

FIG. 10 is a schematic diagram showing radial distance changes on the cam during a 360° rotation of the cam during a complete machine work cycle.

### DESCRIPTION OF THE PREFERRED EMBODIMENTS

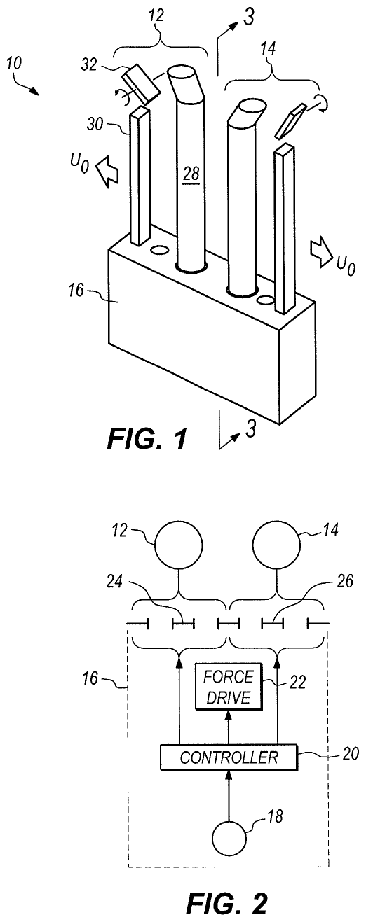

Referring initially to FIG. 1, a machine in accordance with the present invention is shown and is generally designated 10. As shown, machine 10 includes both an electricity generator 12 and an electricity generator 14 which are each mounted vertically on top of a hydro-mechanical drive unit 16, where they are arranged in a back-to-back configuration. In this configuration, FIG. 1 shows that the electricity generator 12 and the electricity generator 14 will separately produce a respective output work Uₒ.

FIG. 2 shows hydro-mechanical drive unit 16 is driven by a mechanical cam drive 18 which is connected to a controller 20 inside the hydro-mechanical drive unit 16. Further, controller 20 is shown electronically connected to a force drive 22, and to both a valving system 24 in the electricity generator 12 and a valving system 26 in the electricity generator 14. Specifically, the valving system 24 provides an hydraulic interface between the force drive 22 and the electricity generator 12 for operating the electricity generator 12. Similarly, the valving system 26 provides an hydraulic interface between the force drive 22 and the electricity generator 14 for operating the electricity generator 14.

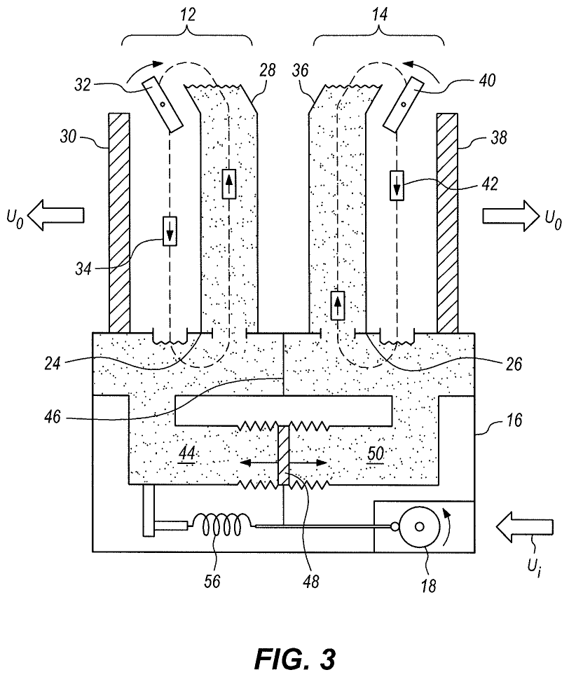

FIG. 3 shows that the electricity generator 12 includes a water tower 28 that is vertically aligned parallel to a linear generator 30. Electricity generator 12 also has a pivot mechanism 32 which is located between the top of water tower 28 and the top of the linear generator 30. The specific purpose of the pivot mechanism 32 is to direct a buoyant shuttle 34 as it breaches from the water tower 28 onto a path between the water tower 36 and the linear generator 30, for travel downwardly toward the hydro-mechanical drive unit 16. During this downward travel the buoyant shuttle 34 engages with the linear generator 30 to generate the output Uₒ.

Similarly, FIG. 3 also shows that the electricity generator 14 likewise includes a water tower 36 that is vertically aligned parallel to a linear generator 38 and, like the electricity generator 12, it also has a pivot mechanism 40. The purpose here of the pivot mechanism 40 is to direct a buoyant shuttle 42 as it breaches from the water tower 36 onto a path between the water tower 36 and the linear generator 38, for travel downwardly toward the hydro-mechanical drive unit 16. During this downward travel the buoyant shuttle 42 engages with the linear generator 38 to generate another output Uₒ.

Still referring to FIG. 3, it will be appreciated that the electricity generator 12 includes a transfer tank 44 which is part of the hydro-mechanical unit 16. More specifically, the transfer tank 44 extends between a partition 46 and a piston 48. Likewise, the electricity generator 14 includes a transfer tank 50 which is also part of the hydro-mechanical unit 16. This transfer tank 50 also extends between the partition 46 and the piston 48. In this combination, the electricity generator 12 and the electricity generator 14 are hydraulically separated from each other. Nevertheless, they are hydraulically interactive with each other via an operation of the piston 48.

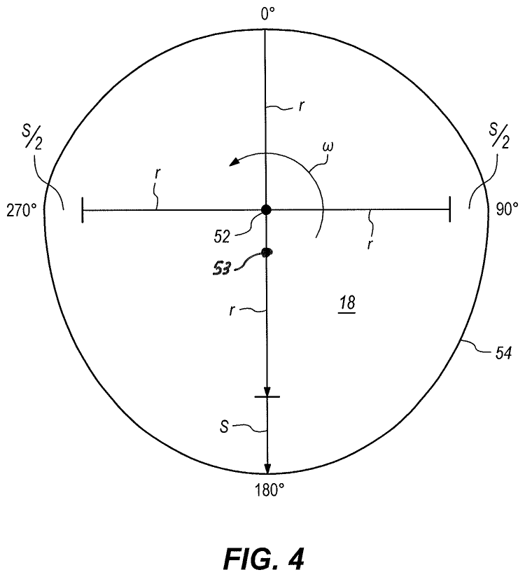

As shown in FIG. 4, a preferred embodiment of the cam drive 18 is a circular shaped disk with an eccentric axis of rotation 52. In detail, the axis of rotation 52 is offset from the center 53 of the cam drive 18 by a distance s/2. Accordingly, the radial distance r from the axis of rotation 52 to the periphery 54 of cam drive 18 increases as a rotation angle θ increases from 0° to 180°. Specifically, the radial distance increases from r to r+s through the arc θ from 0° to 180°, and it decreases from r+s back to r through the arc θ from 180° to 360°.

It is noted here that the increment s which increases the radial distance r, is the same as the reciprocating distance s that is traveled by the piston 48 (i.e. to-and-fro) during a machine work cycle. Specifically, this movement of piston 48 is required to produce an input work unit Uᵢ during a first-half work cycle which maintains operational water levels in the water tower 28 and the transfer tank 44 of electricity generator 12. Further, the increase of s to the radial distance r, is same as the spring compression distance (i.e. spring deformation) distance s of the recoil spring 56 which is required to store an input work unit Uᵢ during the first-half work cycle. This stored input work unit Uᵢ is then subsequently used during the second-half work cycle to maintain operational water levels in the water tower 36 and the transfer tank 50 of electricity generator 14.

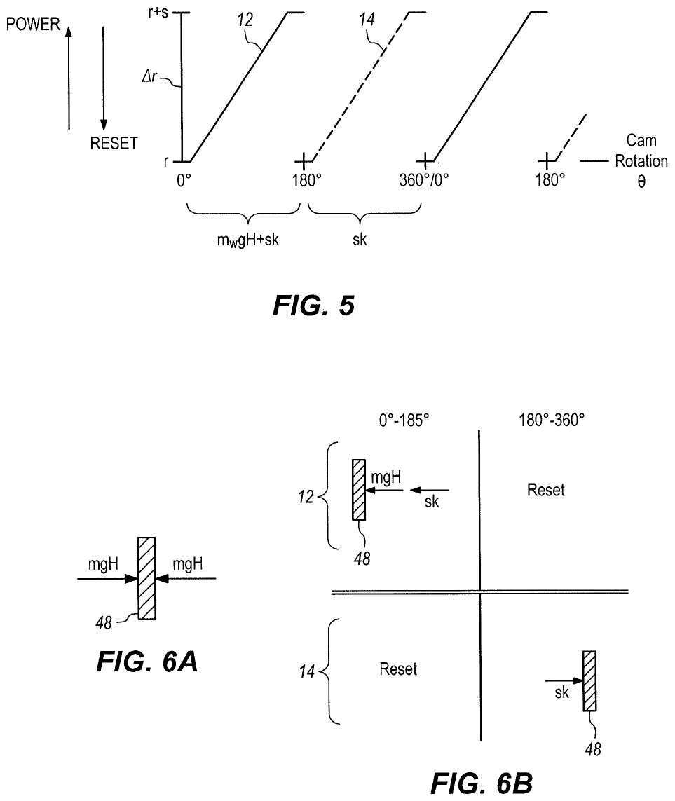

FIG. 5 shows a comparison of input work units Uᵢ generated during comparable work cycles for electricity generator 12 and electricity generator 14. In FIG. 5, changes in Uᵢ for electricity generator 12 are shown as a solid line, and changes in Uᵢ for electricity generator 14 are shown as a dashed line. Further, these changes in Uᵢ are shown horizontally relative to a 360° rotation of the cam drive 18 and vertically relative to a movement of the piston 48 through a distance s. A comparison of the work units Uᵢ for a 360° work cycle is thus illustrative of the operational compatibility of the electricity machines 12/14.

For comparison of input work units Uᵢ for the electricity machines 12/14, specifically consider a complete work cycle caused by a rotation of the cam drive 18 from θ=0° to 360°. In the first-half work cycle, from θ=0° to 180°, the electricity generator 12 is in a power mode wherein two input work units 2Uᵢ are required from the cam drive 18. Specifically, one Uᵢ is required to move the piston 48 and the other Uᵢ is required to compress the recoil spring 56, to thereby store a work unit Uᵢ. Simultaneously, during this first-half cycle, electricity generator 14 is in its reset mode.

In the second-half work cycle, as cam drive 18 rotates from θ=180° to 360°, the electricity generator 12 is in its reset mode. While electricity generator 12 is resetting, the input work unit Uᵢ which has been stored in the compressed recoil spring 56 is provided to drive the piston 48 in the opposite direction. Specifically, the recoil spring 56 extends through the distance s and releases the stored input work unit Uᵢ to thereby operate the electricity generator 14.

In detail, a similar analysis for an operation of the electricity generator 14 of machine 18 during a complete 360° work cycle has the same result as for the electricity machine 12, but with different force applications. Specifically, during a rotation of the cam drive 18 through θ=180°-360°, as the electricity generator 12 is resetting, the electricity generator 14 will use the stored input work Uᵢ=sk from the compressed recoil spring 56 as a recoil force to move the piston 48 in the opposite direction back to its start point. Note: the recoil force also maintains a mechanical contact between the piston 48 and the rotating cam drive 18 which can be engineered into the recoil force by selecting an appropriate spring constant k.

FIGS. 6A and 6B together provide a montage of free-body diagrams depicting forces on the piston 48 that are caused either by the cam drive 18 or by the recoil spring 56. First, in FIG. 6A a steady state depiction of the piston 48 indicates that throughout a 360° machine work cycle, the piston 48 is always subject to the opposing effect of hydraulic forces m_{w}gH from water in the electricity generator 12 and from water in the electricity generator 14. In FIG. 6B, it is shown that during a first-half work cycle, when θ is in the arc 0°-180°, the drive force required from the cam drive 18 to lift water in the electricity generator 12, which equals m_{w}gH, is joined with a recoil force sk from the recoil spring 56. Thus, the force exerted against the piston 48 in its first-half work cycle is two-fold, i.e. m_{w}gH+sk.

During the second-half work cycle of the electricity generator 12, when θ is in the arc 180°-360°, the electricity generator 12 resets. Meanwhile, during this second-half work cycle of the electricity generator 12, the electricity generator 14 is in its comparable first-half work cycle. Thus, as shown in FIG. 6B, the force sk, which is stored in the recoil spring 56 is both stored and released by the recoil spring 56 during each complete work cycle as the angle θ transits a 360° arc around the periphery of the drive cam 18.

During a complete 360° cycle, when θ is in the arc 180°-360°, the piston 48 changes its direction of travel. The force of magnitude sk from recoil spring 56 then acts to move the piston 48 as the recoil spring 56 decompresses to thereby use the stored unit of input work Uᵢ. This time, however, the work Uᵢ operates the electricity generator 14.

In review, when considering the joint operation of the electricity generators 12/14, the total output work generated by a machine 10, i.e. Uₒ₍ₜₒₜₐₗ₎, during each work cycle is best described by the physics involved, namely, the kinetic energy of a shuttle 34 and the power values of each work cycle. In this context, the work/energy relationship shows an operation of the present invention relies on the fact that the work performed by a dynamic object (U=∫Fsds) has the capacity to do this work expressed by the object's kinetic energy (KE=½mₛvₑ²+C). Moreover, the output power, Pₒ, of a machine 10 (Pₒ=Uₒ/sec) is commercially pre-selected. Thus, in a steady state analysis Pₒ will have a given value. Accordingly, Uₒ can be equated with the pre-selected value of Pₒ. Moreover, from the work energy relationship it is known that Uₒ=½mv². Thereafter, based on Pₒ e.g. Uₒ, the only remaining variables that need to be arbitrarily established for a design of the machine 10 are s, the distance of travel for piston 48 and the engagement velocity vₑ of the shuttle 34. With one expression and two variables, one variable needs to be guesstimated.

In accordance with the present invention, designing a machine 10 begins with the selection of a desired output power Pₒ. Based on Pₒ, consideration is given to the variables s for piston travel (i.e. spring deformation distance) and vₑ for the shuttle engagement velocity. Although both s and vₑ are variables, it is the velocity vₑ that is directly related to the length Lₑ of the linear generator 30. Consequently, because vₑ=Lₑ/tₑ, where the is the time duration of engagement between the shuttle 34 and the linear generator 30, the velocity vₑ is an important factor for joint consideration with the length Lₑ of the linear generator 30.

As envisioned for the present invention, a free fall distance L_{f} from a start point above the linear generator 30 must be added to Lₑ. Specifically, L_{f} is needed for shuttle 34 to accelerate to its engagement velocity vₑ for engagement with a linear generator 30/38. Further, the combined length Lₑ+L_{f}, must necessarily be less than the water tower head height H that is needed to raise the shuttle 34 to the start point.

Insofar as the design of a shuttle 34 is concerned, consider the kinetic energy required for the shuttle 34 to provide an output work, Uₒ=½mₛvₑ². Also consider, that the shuttle mass mₛ establishes the shuttle weight Wₛ, i.e. mₛ=Wₛ/g. It has also been shown above that Uₒ/sec=Pₒ. Therefore, by pre-selecting a desired engagement velocity vₑ the values for Uₒ can be used to solve for Wₛ.

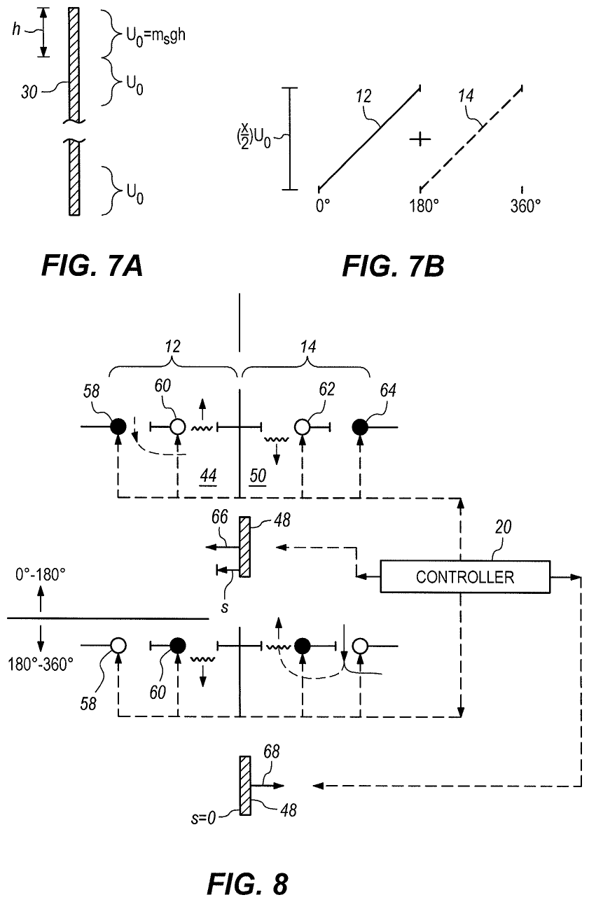

FIG. 7A shows that on a per-second basis, a shuttle weighing Wₛ travelling at the velocity vₑ will travel a length h along the linear generator 30 every second, and will generate one unit of output work Uₒ which equals Wₛh. Also, as disclosed above, during an X second work cycle, the total work output generated is Uₒ₍ₜₒₜₐₗ₎=XUₒ. Furthermore, FIG. 7B illustrates this result during a complete machine work cycle of θ=0°-360°, where it is shown that the combined total output work generated Uₒ₍ₜₒₜₐₗ₎ by both the electricity generator 12 and the electricity generator 14 is XUₒ.

FIG. 8 illustrates how the controller 20 provides for a combined operation of the electricity generators 12 and 14 during a complete machine work cycle θ=0°-360°. For disclosure purposes only, the description of this combined operation is limited here to considerations of the work that is accomplished by the reciprocal back-and-forth movements of the piston 48. This requires specific considerations of the valving system 24 of electricity generator 12, and the valving system 26 of electricity generator 14.

In FIG. 8, the valving system 24 is shown as a combination of the valves 58 and 60, Similarly, the valving system 26 is shown as a combination of the valves 62 and 64. Operationally, the respective valves are shown as darkened circles when closed, and open circles when opened.

To appreciate an operation of the machine 10, first consider the electricity generator 12 separately. In the first-half work cycle for the electricity generator 12, where θ=0°-180°, valve 58 is closed and valve 60 is opened. With this configuration two different operations occur. For one, valve 58 has closed behind shuttle 34 as the shuttle 34 transits through the transfer tank 44 while the valve 60 is opened to provide an exit for the shuttle 34 from the transfer tank 44. For another, with valves 58/60 in this configuration the piston 48 is moved through a distance s in the direction indicated by arrow 66 to displace a predetermined volume of water from the transfer tank 44 into the water tower 28 of electricity generator 12 via the open valve 60.

In the second-half work cycle for the electricity generator 12, where θ=180°-360°, the valve 58 has been opened and valve 60 is has been closed. With this valve configuration, the piston 48 is returned through the distance s in the direction of arrow 68 to the work cycle start point where s=0. This piston movement draws the previously displaced volume of water back from water tower 28 and returns it into the transfer tank 44 of electricity generator 12. This piston movement also resets the electricity generator 12 for the next machine work cycle.

Regarding electricity generator 14, FIG. 8, also shows that successive operations of the electricity generator 12/14 follow each other in their respective θ=180° half work cycles. Stated differently, the electricity generators 12/14 alternately mimic each other during the complete θ=0°-360° machine work cycle.

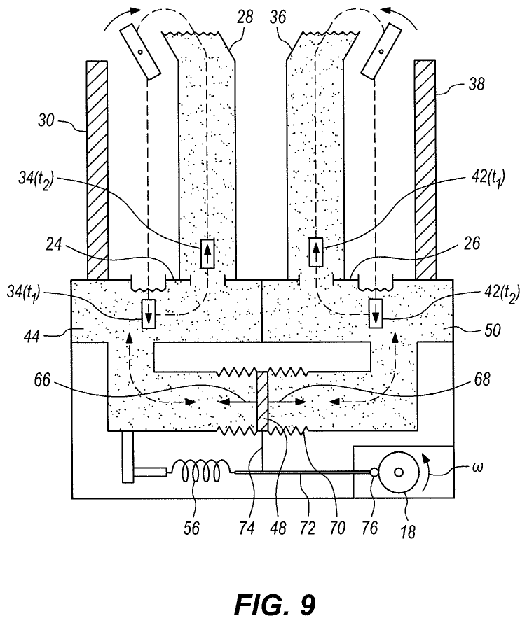

FIG. 9 presents the temporal relationships between respective locations of representative shuttles 34/42 of the electricity generators 12/14, which result from movements of the piston 48, and deformations of the recoil spring 56. For this purpose, the times t₁ and t₂ have been selected for identifying specific locations of the shuttles 34/42 during the machine work cycle θ=0°-360°. Note: the times t₁ and t₂ for shuttle 42 reference the same times t₁ and t₂ for shuttle 34, but at different locations in their respective work cycles. Also note: the times t₁ and t₂ also occur within work cycles having a same time duration.

As disclosed above, during each θ=0°-360° work cycle, the piston 48 is moved cyclically back-and-forth through the distance s. For this operation, the periphery of piston 48 is internally affixed to a bellows 70 which allow the piston 48 to be reciprocated. Simultaneously, as the piston 48 is being cycled, the recoil spring 56 is compressed through a distance s during a half-cycle, and it is decompressed through a same distance s during the subsequent half-cycle. Mechanically, the cyclical operations of the piston 48 and of the recoil spring 56 result from their structural connections with the cam drive 18.

Structurally, a drive rod 72 and an extension 74 from the drive rod 72 together establish a connecting structure for driving the piston 48 and the recoil spring 56. In detail, during a first half-cycle, while the drive rod 72 is being drive by the cam drive 18 to compress the recoil spring 56 the extension 74 which connects with drive rod 72 moves the piston 48 in one direction in the transfer tank 50. During the second half-cycle, the recoil spring 56 moves the piston 48 in the opposite direction in the transfer tank 50, as the recoil spring 56 decompresses.

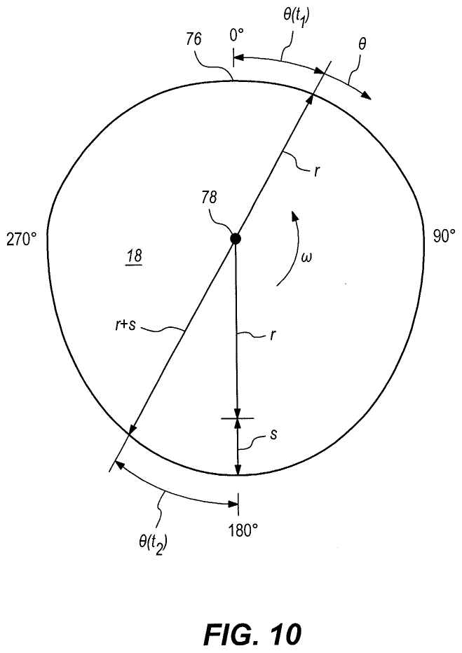

FIG. 10 shows a configuration for an alternate embodiment of the cam drive 18 in which the periphery of the cam drive 18 is slightly modified as the angle θ progresses through a 360° machine work cycle. For reference purposes, the times t₁ and t₂ which were used above in FIG. 9 to identify specific locations of the shuttles 34/42 are associated here with the angle θ during a 360° machine work cycle to provide an operational perspective of the machine 10, relative to a rotation of the cam drive 18.

In FIG. 10, the point on the periphery of cam drive 18, where θ=0°, is selected as a peripheral reference point 76. Beginning at reference point 76, consider a rotation of the cam drive 18 as it is rotated about a center of rotation 78 in a counterclockwise direction at an angular velocity ω. For this alternate embodiment, at θ=0°, the radial distance from the center of rotation 78 to the reference point 76 has a value equal to r. As cam drive 18 begins its rotation through an initial arc length θ(t₁)=0°-5°, which corresponds with time t₁, r can remain constant while needed operational time adjustments for components of the machine 10 can be made. Thereafter, as θ continues to increase from 5° to 180° the radial distance from the center of rotation 78 to the periphery of the cam drive 18 is increased to r+s. As considered here, s is the spring compression distance for the recoil spring 56 as well as the distance moved by the piston 48.

When θ=180° the radial distance from the center of rotation 78 to the reference point 76 has a value equal to r+s. As cam drive 18 continues its rotation e.g. θ(t₂)=180°-185°, r+s can remain constant while the needed operational time adjustments noted above are made. Thereafter, as θ continues to increase from 185° to 360°/0°, the radial distance from the center of rotation 78 to the periphery of the cam drive 18 decreases from r+s back to r as the recoil spring 56 decompresses.

In summary, during each complete work cycle of a machine 10, two units of input work, 2Uᵢ, are simultaneously required from the piston 48. Both, however, are required during the first half-cycle of the machine's operation. One work unit Uᵢ has a value m_{w}gH, which is the work required to manipulate respective water levels in the electricity generator 12. The other Uᵢ is required to compress the recoil spring 34 as the piston 48 moves through a distance s. The value of this input work is Uᵢ=sk. Meanwhile, during the first half cycle of the machine's operation, electricity generator 14 is being reset. In the second half-work cycle these respective operations are reversed. The result is that during a complete, 360° rotation of the cam drive 18, in an X second work cycle, the machine will generate a total output equal to XUₒ. Ergo:

Uₒ₍ₙₑₜ₎=XUₒ−2Uᵢ

A detailed step-by-step disclosure for an operation of the machine 10 is presented below.

### Notations

B is the shuttle buoyancy factor;
g is gravity;
H is the head height for water in the water tower of the machine;
k is a spring constant;
Lₑ is the linear generator length that engages with a shuttle;
L_{f} is the shuttle free fall distance required to achieve an engagement velocity vₑ with the linear generator;
mₛ is the shuttle mass;
m_{w} is the water mass having a same volume as the shuttle;
Pₒ is a commercial output power rating for a machine;
r is a radial distance on the cam drive;
s is the one-way distance of piston reciprocation and spring deformation;
tₑ is the number of seconds of shuttle engagement with a linear generator in a Uₒ time interval;
Uᵢ is the input work required to raise a volume of water of mass m_{w} during a piston reciprocation;
Uᵢ₍ₜₒₜₐₗ₎ is equal to Uᵢ;
Uₒ is the output work accomplished during a predetermined time interval (e.g. one second based on Pₒ);
Uₒ₍ₜₒₜₐₗ₎ is the total output work accomplished during one piston reciprocation;
vₑ is the constant velocity for shuttle engagement with the linear generator;
Wₛ is the shuttle weight;
W_{w} is the weight of water in a volume equal to the shuttle volume;
X is the number per second time intervals needed to accomplish Uₒ₍ₜₒₜₐₗ₎;
θ is the rotation angle of the cam drive; and
ω is angular velocity.

### Step-by-Step Process

Step 1: Pre-select a power value Pₒ for the output work Uₒ/sec that is to be generated separately by each electricity generator of the machine.
Step 2: Pre-select values for the dimensions and operational characteristics for specific components of the machine. Be reasonable. These include B, Lₑ, vₑ, and X; where X=Lₑ/vₑ.
Step 3: Calculate a shuttle weight Wₛ using the equation Pₒ=½mₛvₑ²/sec where mₛ=Wₛ/g.
Step 4: Determine W_{w}=Wₛ/B.
Step 5: Calculate L_{f} where L_{f}=vₑ²/2g.
Step 6: Build a water tank consisting of a transfer tank and a water tower mounted vertically on the transfer tank.
Step 7: Create a mechanical drive unit including a piston plate, a recoil spring, and a cam drive.
Step 8: Manufacture a circular cam drive with an axis of rotation which is offset from the cam center by a distance s/2.
Step 9: Select a spring constant k for the recoil spring.
Step 10 Connect the cam drive with the recoil spring, and with the piston plate, for a simultaneous reciprocal motion of the recoil spring and the piston plate through a distance s in response to a rotation of the cam drive.
Step 11: Calculate the same Uᵢ for each electricity generator, where Uᵢ=W_{w}H=sk, and where H=Lₑ+L_{f}.
Step 12: Transform Uᵢ into a per-second value (i.e. Uᵢ/(X/2)) for compatible comparisons with Pₒ and Uₒ/sec.
Step 13: Determine a finite value for Uᵢ₍ₜₒₜₐₗ₎=Uᵢ+sk where Uᵢ=sk and Uᵢ₍ₜₒₜₐₗ₎=2Uᵢ.
Step 14: Establish a work ratio Uᵢ/Uₒ=W_{w}H/WₛLₑ=Z where Uᵢ=ZUₒ.
Step 15: Evaluate U₍ₙₑₜ₎ for an X second work cycle where U₍ₙₑₜ₎=Uₒ₍ₜₒₜₐₗ₎−Uᵢ₍ₜₒₜₐₗ₎.
Step 16: Solve: U₍ₙₑₜ₎=XUₒ−2Uᵢ or, =XUₒ−2(ZUₒ).

Mathematical calculations for a 100 kW machine which is constructed in accordance with the present invention are provided below to indicate the machine's potential commercial value. These calculations are only exemplary, and are provided primarily to emphasize the design capabilities of a machine, based on an initial commercial objective.

### Mathematical Calculations

In the calculations presented below, the total input work Uᵢ₍ₜₒₜₐₗ₎ is based on the potential energy of a water volume being raised. It equals m_{w}gH. The total output work Uₒ₍ₜₒₜₐₗ₎ is valued on the preselected output power Pₒ for the machine and is based on the kinetic energy of a shuttle during a machine work cycle of X seconds duration. It equals X(½mₛvₑ²). As shown below, the net result is:

U₍ₙₑₜ₎=Uₒ₍ₜₒₜₐₗ₎−Uᵢ₍ₜₒₜₐₗ₎

For a 100 kW machine, calculations for operational components of the machine are provided below.

Pₒ=Uₒ/sec=100 kW=73,756 ft-lbs/sec
Note: Pₒ is pre-selected and is the basis of all design calculations.

B=0.7 shuttle buoyancy factor (pre-selected)

Lₑ=300 ft (pre-selected)

vₑ=50 ft/sec (pre-selected)

L_{f}=vₑ²/2g=(50)2/(2[32.2])=38.82 ft

X=Lₑ/vₑ=seconds per cycle=(300 ft)/(50 ft/sec)=6 seconds

Wₛ=Uₒ(2g)/vₑ²=(73,756 ft-lb [64.4 ft/sec2])/(33.3 ft/sec)2=1,900 lbs:

W_{w}=Wₛ/B=1,900/0.7=2,715 lbs

Uₒ=73,756 ft-lbs

Uₒ₍ₜₒₜₐₗ₎=2XUₒ/cycle=(12)(73,756 ft-lbs)=885,072 ft-lbs
Note: Tandem generator outputs are cumulative for each X seconds cycle.

Uᵢ=W_{w}(Lₑ+L_{f})/X=(2,715 lbs)(300+38.82 ft)/6=153,036 ft-lbs
Note: Uᵢ/sec (153,036 ft-lbs) and Uₒ/sec (73,756 ft-lb/sec), are pertinent for each individual electricity generator. They are considered here in a steady state analysis (i.e. per second) to be compatible with Pₒ=100 kW. Also note: Uᵢ/sec=Uᵢ₍ₜₒₜₐₗ₎/cycle because, unlike Uₒ, Uᵢ is not cumulative and assumes Lₑ+L_{f}=H.

Uᵢ₍ₜₒₜₐₗ₎=Uᵢ+sk=2Uᵢ=306,072 ft-lbs per cycle
Note: sk equals the spring compression which generates Uᵢ for the second electricity generator. As a piston reset force, sk is considered negligible.

Uₒ₍ₙₑₜ₎=Uₒ₍ₜₒₜₐₗ₎−Uᵢ₍ₜₒₜₐₗ₎=885,072/cycle−306,072/cycle=579,000 ft-lb/cycle

While the system and method for generating electricity with tandem towers as herein shown and disclosed in detail is fully capable of obtaining the object and providing the advantages herein before state, it is to be understood that it is merely illustrative of the presently preferred embodiments of the invention and that no limitations are intended to the details of construction or design herein shown other than as described in the appended claims.

What is claimed is:

1. A system for generating electricity which comprises:
a circular cam drive having an excentric axis of rotation;
a piston having opposed fore-and-aft surfaces submerged in a water channel for reciprocating movement therein through a predetermined distance s, wherein the piston is connected with the cam drive for reciprocating movements of the piston responsive to cyclical rotations of the cam drive;
a recoil spring interconnected with the piston and with the cam drive, wherein a compression and a decompression of the recoil spring are response to cyclical rotations of the cam drive; and
a pair of tandem, hydrodynamic, electricity generators separately connected in fluid communication with opposed surfaces of the piston, wherein during a first-half of each 360° cycle rotation of the cam drive, the piston is moved in a forward direction through the distance s by the cam drive to generate a unit of input work Uᵢ for operating one electricity generator and to also compress the recoil spring, and further wherein during a second-half of the 360° cycle the cam drive allows the recoil spring to decompress and thereby move the piston in a backward direction to generate a subsequent unit of input work Uᵢ for operating the other electricity generator.

2. The system of claim 1 wherein each electricity generator is designed to operate at a preselected output power Pₒ during successive work cycles of X seconds duration to do a unit of output work Uₒ every second of a machine work cycle.

3. The system of claim 2 wherein during a first-half work cycle one electricity generator will generate an output work of Uₒ=(X/2)Uₒ and, likewise, during a second-half work cycle the other electricity generator will generate an output work total of Uₒ=(X/2)Uₒ for a machine generated output Uₒ₍ₜₒₜₐₗ₎=2(X/2)Uₒ=XUₒ during a complete work cycle.

4. The system of claim 3 wherein a unit of input work Uᵢ is the work required to manipulate water levels in a water tower to accommodate the transit of a shuttle through the water tower, and wherein Uᵢ=m_{w}gH where m_{w} is the water mass being manipulated, g is gravity and H is the head height of the water tower.

5. The system of claim 4 further comprising at least one shuttle which is positioned by the electricity generator with one input work unit Uᵢ to fall from the top of the water tower and engage with the linear generator to do a unit of output work Uₒ during every second of its engagement, wherein Uₒ is based on Pₒ, and further wherein Uₒ equals the kinetic energy of the shuttle expressed as ½mₛvₑ² where mₛ is the shuttle mass and vₑ is the constant velocity of the shuttle during shuttle engagement with the linear generator.

6. The system of claim 5 wherein the Uᵢ for a piston movement through the reciprocating distance s and equals m_{w}gH, and the Uᵢ for recoil spring compression equals sk, where m_{w}gH=sk, where s is the compression distance of the recoil spring and k is the spring constant.

7. The system of claim 6 wherein one input work unit Uᵢ from the piston drives one electricity generator during a first-half work cycle and the other input work unit Uᵢ from the recoil spring drives the other electricity generator during a second-half work cycle, wherein the input work units Uᵢ are finite, time independent, and additive, for a total input work requirement during an X second machine work cycle of Uᵢ₍ₜₒₜₐₗ₎=2Uᵢ.

8. The system of claim 7 wherein the system is self-sustaining with closed loop feedback wherein Uₒ₍ₙₑₜ₎=Uₒ₍ₜₒₜₐₗ₎−Uᵢ₍ₜₒₜₐₗ₎, for a U₍ₙₑₜ₎=XUₒ−2Uᵢ.

9. A method for manufacturing and using a machine to generate electricity which comprises the steps of:
providing a pair of identical electricity generators, wherein each electricity generator includes a water tower vertically oriented in a juxtaposed combination with a linear generator;
separately connecting opposite ends of a water channel in fluid communication with the water tower of a respective electricity generator;
joining the periphery of a piston with a water-tight connection to the water channel at a location inside the water channel between the opposite ends thereof, for a reciprocating movement of the piston back and forth inside the water channel through a predetermined distance s;
affixing the piston and a recoil spring to a drive bar; and
engaging a cam drive with the drive bar to simultaneously reciprocate the piston in the water channel while exercising the recoil spring to alternatingly compress and decompress outside the water channel.

10. The method of claim 9 wherein each electricity generator is designed to operate at a preselected output power Pₒ during successive work cycles of X seconds duration to do a unit of output work Uₒ every second of a machine work cycle.

11. The method of claim 10 further comprising the step of off-setting an axis of rotation for the drive cam from the center of the drive cam by a distance of s/2.

12. The method of claim 11 wherein the electricity generators are sequentially operated with one electricity generator generating an output work of Uₒ=(X/2)Uₒ during a first-half work cycle and with the other electricity generator generating an output work of Uₒ=(X/2)Uₒ during a second-half work cycle, for a machine generated output Uₒ₍ₜₒₜₐₗ₎=2(X/2)Uₒ=XUₒ during a complete work cycle.

13. The method of claim 12 wherein one input work unit Uᵢ from the piston drives one electricity generator during a first-half work cycle and the other input work unit Uᵢ from the recoil spring drives the other electricity generator during a second-half work cycle, wherein the input work units Uᵢ are finite, time independent, and additive, for a total input work requirement during an X second machine work cycle of Uᵢ₍ₜₒₜₐₗ₎=2Uᵢ.

14. The method of claim 13 wherein the total input work Uᵢ₍ₜₒₜₐₗ₎ required during the first-half cycle includes work based on the potential energy of the water volume to be manipulated and equals Uᵢ=m_{w}gH where m_{w} is the water mass being manipulated, g is gravity and H is the head height of the water tower, and wherein Uᵢ₍ₜₒₜₐₗ₎ also includes the work required to compress the recoil spring which equal sk, where m_{w}gH=sk, where s is the compression distance of the recoil spring and k is the spring constant, and further wherein Uₒ₍ₜₒₜₐₗ₎ is based on the cumulative value of Uₒ for Pₒ during an X second work cycle where Uₒ is valued as the kinetic energy of the shuttle expressed as ½mₛvₑ² where mₛ is the shuttle mass and vₑ is the constant velocity of the shuttle during shuttle engagement with the linear generator.

15. The method of claim 14 wherein the system is self-sustaining with closed loop feedback wherein Uₒ₍ₙₑₜ₎=Uₒ₍ₜₒₜₐₗ₎−Uᵢ₍ₜₒₜₐₗ₎, for a Uₒ₍ₜₒₜₐₗ₎=XUₒ−2Uᵢ.

16. A system for generating electricity which comprises:
a pair of identical electricity generators, wherein each electricity generator includes a water tower vertically oriented in a juxtaposed combination with a linear generator;
a means for reciprocating a piston back and forth inside the water channel through a predetermined distance s to manipulate water levels in the water towers of respective electricity generators to accommodate the transit of a shuttle through the water tower;
a means for exercising a recoil spring to alternatingly compress and decompress the recoil spring outside the water channel;
a means for simultaneously driving the reciprocating means and the exercising means to do one input work unit Uᵢ from the piston for one electricity generator during a first-half work cycle and to do another input work unit Uᵢ from the compressed recoil spring for the other electricity generator during a second-half work cycle, for a total input work requirement for the pair of electricity generators during an X second machine work cycle of Uᵢ₍ₜₒₜₐₗ₎=2Uᵢ; and
a means for sequentially operating one electricity generator to generate an output work of Uₒ=(X/2)Uₒ during the first-half work cycle and then operating the other electricity generator to generate an output work of Uₒ=(X/2)Uₒ during the second-half work cycle, for a machine generated output Uₒ₍ₜₒₜₐₗ₎=2(X/2)Uₒ=XUₒ during a complete work cycle.

17. The system of claim 16 wherein the Uᵢ required to manipulate water levels with the piston equals Uᵢ=m_{w}gH where m_{w} is the water mass being manipulated, g is gravity and H is the head height of the water tower, and wherein the Uᵢ required to compress the recoil spring equals sk, where m_{w}gH=sk, where s is the compression distance of the recoil spring and k is the spring constant.

18. The system of claim 17 wherein Uₒ₍ₜₒₜₐₗ₎ is based on the cumulative value of Uₒ having a preselected power value Pₒ, and is accrued during the X second work cycle where Uₒ is valued as the kinetic energy of the shuttle expressed as ½mₛvₑ², where mₛ is the shuttle mass and vₑ is the constant velocity of the shuttle during shuttle engagement with the linear generator.

19. The system of claim 18 wherein the exercising means is a circular drive cam having an axis of rotation off-set from the center of the cam by a distance s/2.

20. The system of claim 19 wherein the system is self-sustaining with closed loop feedback wherein Uₒ₍ₙₑₜ₎=Uₒ₍ₜₒₜₐₗ₎−Uᵢ₍ₜₒₜₐₗ₎, for a Uₒ₍ₙₑₜ₎=XUₒ−2Uᵢ.
